(19) United States
(12) Patent Application Publication
(10) Pub. No.: US 2019/0101468 A1
(43) Pub. Date: Apr. 4, 2019

(54) DETECTOR FOR A LABORATORY LIQUID DISTRIBUTION SYSTEM, DETECTOR SYSTEM FOR A LABORATORY LIQUID DISTRIBUTION SYSTEM, LABORATORY LIQUID DISTRIBUTION SYSTEM, LABORATORY AUTOMATION SYSTEM AND USE OF A DETECTOR

(71) Applicant: Roche Diagnostics Operations, Inc., Indianapolis, IN (US)

(72) Inventor: Arindam Haldar, Waiblingen (DE)

(21) Appl. No.: 16/143,886

(22) Filed: Sep. 27, 2018

(30) Foreign Application Priority Data
Oct. 4, 2017 (EP) 17194744.3

(51) Int. Cl. G01M 3/18; B01L 3/00; G01N 35/10

(52) U.S. Cl. CPC G01M 3/186; G01N 35/1009; B01L 3/56

(57) ABSTRACT

A detector for a laboratory liquid distribution system is presented. A detector system for a laboratory liquid distribution system comprising such a detector, a laboratory liquid distribution system comprising such a detector and/or such a detector system, a laboratory automation system comprising such a laboratory liquid distribution system and a use of such a detector are also presented.

### CROSS-REFERENCE TO RELATED APPLICATIONS

This application claims priority to EP 17194744.3, filed Oct. 4, 2017, which is hereby incorporated by reference.

### BACKGROUND

The present disclosure generally relates to a detector for a laboratory liquid distribution system, a detector system for a laboratory liquid distribution system comprising such a detector, a laboratory liquid distribution system comprising such a detector and/or such a detector system, a laboratory automation system comprising such a laboratory liquid distribution system and a use of such a detector.

Known laboratory automation systems typically comprise a number of laboratory stations. The laboratory stations may require laboratory liquid containers such as tubes to be open for processing, in particular analyzing, liquids contained in the laboratory liquid containers. Furthermore, the laboratory automation systems typically comprise a laboratory liquid distribution system in order to distribute or to move the liquids contained in the open laboratory liquid containers between the number of laboratory stations.

However, there is a need for a detector for a laboratory liquid distribution system to detect problems of the laboratory liquid distribution system, a detector system comprising such a detector, a laboratory liquid distribution system comprising such a detector and/or such a detector system, a laboratory automation system comprising such a laboratory liquid distribution system and a use of such a detector

### SUMMARY

According to the present disclosure, a detector for a laboratory liquid distribution system is presented. The detector can comprise an electrical sensor configured to be arranged at a laboratory liquid container within reach of a liquid contained in the laboratory liquid container and to generate an electrical sensor signal (ES) when the liquid contacts the electrical sensor.

Accordingly, it is a feature of the embodiments of the present disclosure to provide a detector for a laboratory liquid distribution system to detect problems of the laboratory liquid distribution system, a detector system comprising such a detector, a laboratory liquid distribution system comprising such a detector and/or such a detector system, a laboratory automation system comprising such a laboratory liquid distribution system and a use of such a detector Other features of the embodiments of the present disclosure will be apparent in light of the description of the disclosure embodied herein.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates perspective view of a detector system comprising a detector according to an embodiment of the present disclosure.

FIG. 2 illustrates another perspective view of the detector system of FIG. 1 according to an embodiment of the present disclosure.

FIG. 3 illustrates a view from below of an electrical sensor of the detector of FIG. 1 according to an embodiment of the present disclosure.

FIG. 4 illustrates a perspective view of a laboratory automation system comprising a laboratory liquid distribution system comprising the detector system of FIG. 1 according to an embodiment of the present disclosure.

FIG. 5 illustrates a longitudinal section view of a liquid container carrier of the laboratory liquid distribution system of FIG. 4 carrying a laboratory liquid container containing a liquid according to an embodiment of the present disclosure.

### DETAILED DESCRIPTION

In the following detailed description of the embodiments, reference is made to the accompanying drawings that form a part hereof, and in which are shown by way of illustration, and not by way of limitation, specific embodiments in which the disclosure may be practiced. It is to be understood that other embodiments may be utilized and that logical, mechanical and electrical changes may be made without departing from the spirit and scope of the present disclosure.

A detector for a laboratory liquid distribution system is presented. The detector can comprise an electrical sensor. The electrical sensor can be configured to be arranged at a laboratory liquid container within reach of a liquid contained in or by the laboratory liquid container. Furthermore, the electrical sensor can be configured to generate an electrical sensor signal when the liquid contacts such as, for example, directly contacts, the electrical sensor.

The detector can detect a displacement or movement, respectively, of the liquid within the laboratory liquid container. The displacement of the liquid may be caused by a movement or a distribution of the laboratory liquid container in an undesired manner in or by the laboratory liquid distribution system. The undesired movement of the laboratory liquid container may be caused by an irregularity or a fault, respectively, of the laboratory liquid distribution system. Thereby, the detector can detect the irregularity of the laboratory liquid distribution system such as, for example, when and/or where the irregularity occurs.

In one embodiment, the displacement of the liquid may be undesired because, in the case of the laboratory liquid container being open, the liquid may spill out of the laboratory liquid container. The detector can reduce or to prevent spilling of the liquid contained in the open laboratory liquid container out of the laboratory sample container during the movement of the open laboratory liquid container by or in the laboratory liquid distribution system. Thereby, contamination of the laboratory liquid distribution system and/or other laboratory liquid containers and/or other liquids may be reduced or prevented. The detector may be denoted also as spilling detector. The electrical sensor may be denoted as electrical spilling sensor.

The laboratory liquid container may be designed as a tube and/or may have an opening at an upper and/or top end. The laboratory liquid container may be made of glass or transparent plastic. The liquid may be a laboratory sample such as a blood sample, a urine sample or a chemical sample. The laboratory liquid container may be denoted as laboratory sample container. The laboratory liquid distribution system may be denoted as laboratory sample distribution system. Alternatively, the liquid may be a test liquid such as an aqueous salt solution. The laboratory liquid container and its opening, respectively, may be closed by a cap or a closure, respectively. The cap may comprise rubber and/or plastic or may completely consist of rubber and/or plastic. The cap may be embodied as a lid, in particular as a rigid lid, or as a foil, in particular a flexible foil. Typically, the liquid will not fill the laboratory liquid container completely such as, for example, up to the opening, if present.

Arranged at the laboratory liquid container within reach of the liquid may denote, that the electrical sensor may be arranged, such that the liquid does not contact the electrical sensor in a problem-free state of the laboratory liquid container such as, for example, during the movement of the laboratory liquid container by the laboratory liquid distribution system without any problems. Furthermore, within reach of the liquid may denote, that the electrical sensor may be arranged, such that the liquid may be displaced towards the electrical sensor and may contact the electrical sensor in a problematic state of the laboratory liquid container such as, for example, during the movement of the laboratory liquid container by the laboratory liquid distribution system with a problem. In one embodiment, the electrical sensor may be arranged at the laboratory liquid container such that the electrical sensor can cover an end portion of the laboratory liquid container. Additionally, or alternatively, arranged at the laboratory liquid container within reach of the liquid may denote, that a vertical distance different from zero such as, for example, in one embodiment, about 5 millimeter (mm), in another embodiment about 10 mm, and in still another embodiment about 20 mm, may be present between the electrical sensor and the liquid contained in the laboratory liquid container such as, for example, when the laboratory liquid container stands still and/or is not moved, respectively.

A drop of the liquid contacting the electrical sensor may be sufficient for the electrical sensor to generate the electrical sensor signal. The electrical sensor may be configured to generate the electrical sensor signal as soon as the liquid contacts the electrical sensor. Thereby, the detector may detect the moment and/or the place of the irregularity.

According to an embodiment, the electrical sensor can be configured to cover the opening of the laboratory liquid container. Thereby, the detector can detect a displacement of the liquid towards the opening. In one embodiment, the detector may be arranged in a plane defined by the opening. Additionally, or alternatively, the detector may be arranged within the laboratory liquid container. The opening does not have to be open.

According to an embodiment, the electrical sensor can have a sensing area such as, for example, an electrical sensing area. The electrical sensor can be configured to generate the electrical sensor signal when the liquid contacts the sensing area. The size of the sensing area can be in the range of about 50 square millimeters (mm²) to about 400 mm², in one embodiment in the range of about 100 mm² to about 300 mm², and in another embodiment, in the range of about 150 mm² to about 250 mm². This size can correspond to the cross section size of a typical laboratory sample tube. Furthermore, a form of the sensing area may be angled such as, for example, rectangular such as, for example, quadratic, or round such as, for example, circular. In one embodiment, the size and/or the form of the sensing area may be adjusted or adapted, respectively, to a size and/or a form of the opening, if present, of the laboratory liquid container.

According to an embodiment, the electrical sensor can comprise a pair of exposed electrodes. The pair of exposed electrodes can be configured to be electrically connected by the liquid and to generate the electrical sensor signal when the liquid contacts the pair of exposed electrodes. This sensor principle can allow the electrical sensor to be relatively lightweight. In other words, a maximum distance between the pair of exposed electrodes may be about 1000 micrometer (μm) and, in one embodiment, about 400 μm. This can enable a drop of the liquid having a typical size to electrically connect the pair of exposed electrodes. Exposed may denote, that the liquid may reach and contact the pair of exposed electrodes. In other words, the electrodes may at least partially have no insulation. The liquid in the form of a laboratory sample such as, for example, a blood sample or the urine sample as well as in the form of a test liquid such as an aqueous salt solution typically is electrically conductive and, thereby, may electrically connect or short-circuit the pair of exposed electrodes.

According to an embodiment, the detector can comprise a mount. The mount can be configured to mount the electrical sensor at the laboratory liquid container within reach of the liquid. In one embodiment, the mount may be configured to mount the electrical sensor at the laboratory liquid container by a form fit and a form closure, respectively, and/or by a force fit and a force closure, respectively, and/or by an adhesive bond. The mount may be a mechanical mount such as at least one leg and/or at least one tape.

According to an embodiment, the detector can comprise a signal output. The signal output can be electrically connected with the electrical sensor and can be configured to output or a detector signal in dependence of or based on the generated electrical sensor signal. In one embodiment, the signal output may output the detector signal as soon as the electrical sensor signal is generated. The signal output may not have to output any detector signal when no electrical sensor signal is generated. In one embodiment, the signal output may convert the electrical sensor signal into the detector signal. The electrical sensor, the signal output and the mount, if present, may be configured to be, in particular mechanically, connected to only one structural detector unit or may form or be embodied as one structural detector unit.

According to an embodiment, the signal output can be a wireless signal output. The wireless signal output can be configured to output the detector signal as or in the form of a wireless detector signal. In one embodiment, the wireless signal output may comprise a light source such as a light-emitting diode, wherein the light source may be configured to output the wireless detector signal as a light signal. The light signal may be received by a light detector such as a camera such as, for example, a high-speed camera. Additionally, or alternatively, the wireless signal output may comprise a radio transmitter such as a Bluetooth transmitter, wherein the radio transmitter may be configured to output the wireless detector signal as a radio signal.

The radio signal may be received by a radio receiver such as a Bluetooth receiver.

According to an embodiment, the detector can comprise an inertial sensor. The inertial sensor can be configured to be arranged in the region of the laboratory liquid container such as, for example, at the laboratory liquid container, to cooperate with the electrical sensor and to generate an inertial sensor signal comprising an inertial value in dependence of or based on the generated electrical sensor signal. This can enable to the determination of the intensity, the grade or the magnitude, respectively, of the irregularity of the laboratory liquid distribution system. In one embodiment, the inertial sensor may comprise or be at least one accelerometer and/or at least one gyroscope. Arranged in the region of the laboratory liquid container may denote, that the inertial sensor may be arranged, such that the inertial sensor may experience the same movement such as, for example, the same acceleration or the same deceleration, as the laboratory liquid container in the laboratory liquid distribution system. The inertial sensor may be configured to generate the inertial sensor signal when the electrical sensor signal is generated such as, for example, as soon as the electrical sensor signal is generated. The inertial sensor signal comprising the inertial value may be output by the signal output, if present, such as, for example, as the detector signal. The electrical sensor, the inertial sensor, the signal output, if present, and the mount, if present, may be configured to be such as, for example, mechanically, connected to only one structural detector unit or may form or be embodied as one structural detector unit.

A detector system for a laboratory liquid distribution system is presented. The detector system can comprise a laboratory liquid container containing a liquid and a detector as described above. The electrical sensor can be arranged at the laboratory liquid container within reach of the liquid.

In one embodiment, the detector may be arranged within the laboratory liquid container. The laboratory liquid container and/or the liquid may be embodied as described above. The laboratory liquid container containing the liquid and the arranged electrical sensor may be denoted as detector container such as, for example, as spilling detector container.

A detector system for a laboratory liquid distribution system is presented. The detector system can comprise a liquid container carrier. The liquid container carrier can be configured to carry at least one laboratory liquid container containing a liquid. Furthermore, the detector system can comprise a detector as described above. The detector can be carried by the liquid container carrier.

The liquid container carrier may be denoted as sample container carrier. Carried may denote, that the detector can be mounted at the liquid container carrier or even integrated into the liquid container carrier. The liquid container carrier and the detector may be denoted as detector carrier such as, for example, as spilling detector carrier.

In one embodiment, the detector system may comprise the laboratory liquid container containing the liquid, the detector and the liquid container carrier, wherein the laboratory liquid container and the detector may be carried by the liquid container carrier. The laboratory liquid container containing the liquid, the detector and the liquid container carrier may be configured to be such as, for example, mechanically, connected to only one structural detector unit or may form or be embodied as one structural detector unit.

A laboratory liquid distribution system is also presented. The laboratory liquid distribution system can comprise a plurality of liquid container carriers (e.g., 1 to 1000), a transport plane, a plurality of drive elements (e.g., 1 to 10000), a control device, and a detector as described above and/or a detector system as described above. Each of the plurality of liquid container carriers can be configured to carry at least one laboratory liquid container containing a liquid. The transport plane can be configured to support the plurality of liquid container carriers. The plurality of drive elements can be configured to move the plurality of liquid container carriers on the transport plane. The control device can be configured to control the plurality of drive elements such that the plurality of liquid container carriers moves on the transport plane along corresponding transport paths.

The transport plane may also be denoted as transport surface. The transport plane may support the number of liquid container carriers, what may also be denoted as carrying the plurality of liquid container carriers. Each of the plurality of liquid container carriers may be translationally moved on the transport plane. Furthermore, each of the plurality of liquid container carriers may be configured to move in two dimensions on the transport plane. Moreover, each of the plurality of liquid container carriers may slide over the transport plane. Further, each of the plurality of liquid container carriers may move on the transport plane along an individual transport path simultaneously.

The plurality of drive elements may comprise or be formed as a plurality of wheels driven by a plurality of corresponding electric motors located in the plurality of liquid container carriers and controllable by the control device.

The control device may comprise or be an integrated circuit, a tablet computer, a smartphone or a computer.

The detector or the detector system can detect an irregularity of the laboratory liquid distribution system. In one embodiment, the transport plane may comprise a step, a bump or a hole and/or have a different surface friction at different positions, which may cause the irregularity. In dependence of or based on the electrical sensor signal and/or the detector signal and/or the inertial sensor signal, the transport plane may be modified or treated in order to reduce or to remove the irregularity. Additionally, or alternatively, the plurality of drive elements may accelerate or decelerate the plurality of laboratory liquid containers in an undesired manner, which may cause the irregularity. In dependence of or based on the electrical sensor signal and/or the detector signal and/or the inertial sensor signal, the plurality of drive elements and/or the control device may be modified or treated in order to reduce or to remove the irregularity.

According to an embodiment, the laboratory liquid distribution system can comprise a signal receiver. The signal receiver can be configured to receive the electrical sensor signal and/or the detector signal and/or the inertial sensor signal. The control device can be configured to cooperate with the signal receiver and can be configured to control the plurality of drive elements in dependence of or based on the received electrical sensor signal and/or the received detector signal and/or the received inertial sensor signal. This can reduce or remove an irregularity automatically. In one embodiment, the signal receiver may be a wireless signal receiver. The wireless signal receiver may comprise or be a light detector and/or a radio receiver. In one embodiment, the control device may be configured to control the plurality of drive elements such that the electrical sensor may not be contacted by the liquid and no further signal can be received by the signal receiver.

According to an embodiment, each of the plurality of liquid container carriers can comprise a magnetically active device. The plurality of drive elements can comprise a plurality of electro-magnetic actuators. The plurality of electro-magnetic actuators can be stationary arranged below the transport plane and can be configured to move the plurality of liquid container carriers on the transport plane by applying a magnetic drive force to the plurality of liquid container carriers. The control device can be configured to control the plurality of electro-magnetic actuators such that the plurality of liquid container carriers can move on the transport plane along corresponding transport paths.

In one embodiment, the magnetically active device may be a permanent magnet or an electro-magnet. Additionally, or alternatively, the magnetically active device may comprise a magnetically soft material. The plurality of electro-magnetic actuators may be configured to generate a magnetic field. The magnetically active device may be configured to interact with the magnetic field generated by the plurality of electro-magnetic actuators such that the magnetic drive force may be applied to a corresponding liquid container carrier. In one embodiment, the plurality of electro-magnetic actuators may be a plurality of solenoids surrounding a plurality of ferromagnetic cores. Furthermore, the plurality of electro-magnetic actuators may be driven or energized individually in order to generate or to provide the magnetic field. Moreover, the electro-magnetic actuators may be arranged in two dimensions such as, for example, in a grid having rows and columns. Further, the plurality of electro-magnetic actuators may be arranged in a plane substantially parallel to the transport plane.

The plurality of electro-magnetic actuators may accelerate or decelerate the plurality of laboratory liquid containers in an undesired manner which may cause the irregularity. In dependence of or based on the electrical sensor signal and/or the detector signal and/or the inertial sensor signal, the plurality of electro-magnetic actuators and/or the control device may be modified or treated in order to reduce or to remove the irregularity.

A laboratory automation system is also presented. The laboratory automation system can comprise a plurality of laboratory stations and a laboratory liquid distribution system as described above. The laboratory liquid distribution system can be configured to distribute or to move the plurality of liquid container carriers and/or laboratory liquid containers and/or the liquid/s, if present, between the laboratory stations.

The laboratory stations may be arranged adjacent or directly next to the laboratory liquid distribution system such as, for example, to the transport plane of the laboratory liquid distribution system. The plurality of laboratory stations may comprise pre-analytical, analytical and/or post-analytical laboratory stations. Pre-analytical laboratory stations may be configured to perform any kind of pre-processing of liquids, laboratory liquid containers and/or liquid container carriers. Analytical laboratory stations may be configured to use a liquid or a part of the liquid and a reagent to generate a measuring signal, the measuring signal indicating if and in which concentration, if any, an analyte exists. Post-analytical laboratory stations may be configured to perform any kind of post-processing of liquids, laboratory liquid containers and/or liquid container carriers. The pre-analytical, analytical and/or post-analytical laboratory stations may comprise at least one of a decapping station, a recapping station, an aliquot station, a centrifugation station, an archiving station, a pipetting station, a sorting station, a tube type identification station, a liquid quality determining station, an add-on buffer station, a liquid level detection station, a sealing/desealing station, a pushing station, a belt station, a conveying system station and/or a gripper station for moving the laboratory liquid container to or from the liquid container carrier.

The use of a detector as described above with a laboratory liquid container containing a liquid in a laboratory liquid distribution system is presented. In other words, a method to validate the transport or movement function of a laboratory liquid distribution system by using a detector as described above is presented.

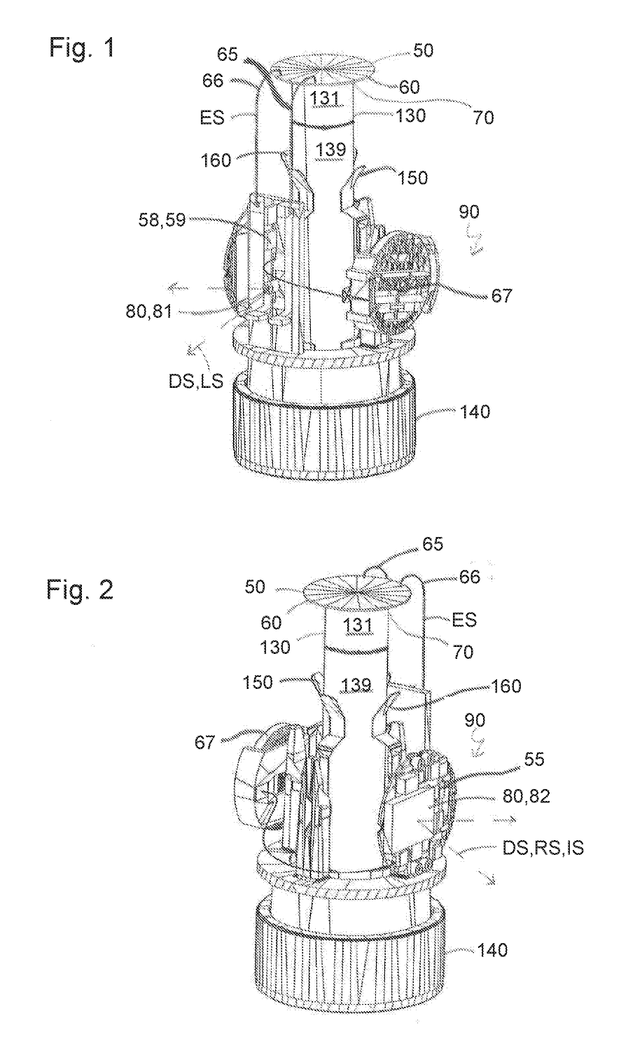

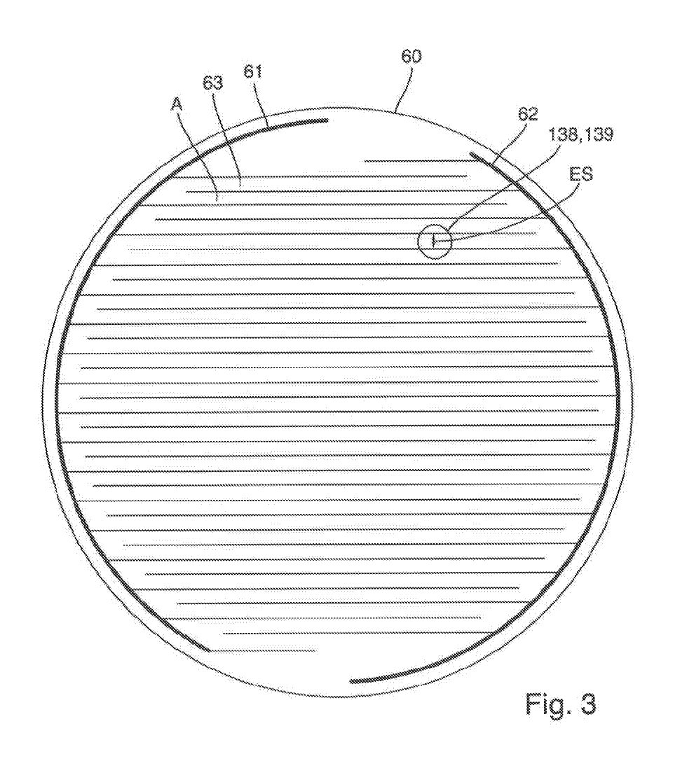

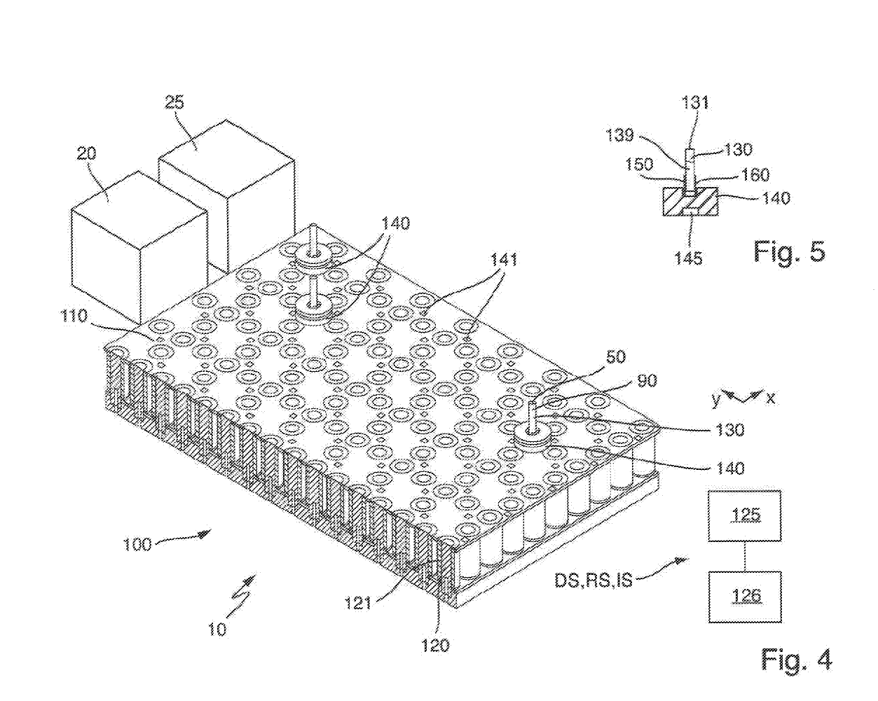

FIGS. 1 and 2 show a detector system 90 for a laboratory liquid distribution system 100 as shown in FIG. 4. The detector system 90 can comprise a detector 50 for the laboratory liquid distribution system 100. Furthermore, the detector system 90 can comprise a laboratory liquid container 130 containing a liquid 139. Moreover, the detector system 90 can comprise a liquid container carrier 140. In alternative embodiments, the detector system either may not have to comprise the laboratory liquid container containing the liquid or may not have to comprise the liquid container carrier.

The detector 50 can comprise an electrical sensor 60. The electrical sensor 60 can be configured to be arranged at the laboratory liquid container 130 within reach of the liquid 139 contained in the laboratory liquid container 130. In the shown embodiment, the electrical sensor 60 can be arranged at the laboratory liquid container 130 within reach of the liquid 139. Furthermore, the electrical sensor 60 can be configured to generate an electrical sensor signal (ES) when the liquid 139 contacts the electrical sensor 60.

The liquid container carrier 140 can be configured to carry the at least one, in the shown embodiment only one, laboratory liquid container 130 containing the liquid 139. In the shown embodiment, the liquid container carrier 140 can carry the laboratory liquid container 130 containing the liquid 139. Moreover, the detector 50 can be carried by the liquid container carrier 140.

In the shown embodiment, the laboratory liquid container 130 can be designed as a tube and can have an opening 131 such as, for example, at an upper end region, as shown in FIGS. 1 and 2.

In detail, the electrical sensor 60 can be configured to cover the opening 131 of the laboratory liquid container 130. In the shown embodiment, the electrical sensor 60 can cover the opening 131. Hence, the opening 131 can be closed by the electrical sensor 60.

Further, the electrical sensor 60 can have a sensing area 63, as shown in FIG. 3. The electrical sensor 60 can be configured to generate the electrical sensor signal (ES) when the liquid 139 contacts the sensing area 63. A size (A) of the sensing area 63 can be in the range of about 50 mm² to about 400 mm², and in another embodiment, in the range of about 100 mm² to about 300 mm², and in yet another embodiment, in the range of about 150 mm² to about 250 mm². In the shown embodiment, the opening 131 can have a diameter of about 16.5 mm. The size (A) of the sensing area 63 can correspond to a cross section size of the laboratory liquid container 130 and its opening 131, respectively. In detail, the size (A) can be about 214 mm². Furthermore, a form of the sensing area 63 can correspond to a form of the opening 131, namely the form can be circular.

Moreover, the electrical sensor 60 can comprise a pair of exposed electrodes 61, 62. The pair of exposed electrodes 61, 62 can be configured to be electrically connected by the liquid 139 and to generate the electrical sensor signal (ES) when the liquid 139 contacts the pair of exposed electrodes 61, 62.

In the shown embodiment, the exposed electrodes 61, 62 can each have a comb-like structure, which can engage each other. The pair of exposed electrodes 61, 62 can form or define the sensing area 63 and its size A, respectively.

A maximum distance between the pair of exposed electrodes 61, 62 such as, for example, of successive arms of the pair of exposed electrodes 61, 62, can be about 400 μm. This can enable a drop 138 of the electrically conductive liquid 139 to electrically connect the pair of exposed electrodes 61, 62. Thereby, the drop 138 contacting the electrical sensor 60 can be sufficient for the electrical sensor 60 to generate the electrical sensor signal (ES).

In detail, an electrical voltage can be applied in between the pair of exposed electrodes 61, 62 through wires 65, 66 by an electrical power supply 67 in the form of a battery such as, for example, a coin battery. When the liquid 139 electrically connects the pair of exposed electrodes 61, 62, an electrical current can flow through the pair of exposed electrodes 61, 62, which can cause or is the electrical sensor signal (ES).

Further, the detector 50 can comprise a mount 70. The mount 70 can be configured to mount the electrical sensor 60 at the laboratory liquid container 130 within reach of the liquid 139 such as, in the shown embodiment, on top of the laboratory liquid container 130 covering the opening 131 by its sensing area 63. In detail, the mount 70 can be configured to mount, and mounts in the shown embodiment, the electrical sensor 60 at the laboratory liquid container 130 by an adhesive bond. In alternative embodiments, additionally, or alternatively, the mount may be configured to mount the electrical sensor at the laboratory liquid container by a form fit and a form closure, respectively, and/or by a force fit and a force closure, respectively.

Furthermore, the detector 50 can comprise a signal output 80. The signal output 80 can be electrically connected with the electrical sensor 60 and can be configured to output or a detector signal (DS) in dependence of the generated electrical sensor signal (ES).

In detail, the signal output 80 can be a wireless signal output 81, 82. The wireless signal output 81, 82 can be configured to output the detector signal (DS) as a wireless detector signal (LS, RS).

In the shown embodiment, the wireless signal output can comprise a light source 81 in the form of a light-emitting diode, wherein the light source 81 can be configured to output the wireless detector signal as a light signal (LS). Additionally, the wireless signal output can comprise a radio transmitter 82 in the form of a Bluetooth transmitter, wherein the radio transmitter 82 can be configured to output the wireless detector signal as a radio signal (RS). In alternative embodiments, it may be sufficient, if the wireless signal output comprises either the light source or the radio transmitter.

Moreover, the detector 50 can comprise an inertial sensor 55 in the form of an acceleration and gyro sensor. The inertial sensor 55 can be configured to be arranged in the region of the laboratory liquid container 130 to cooperate with the electrical sensor 60 and to generate an inertial sensor signal (IS) comprising an inertial value in dependence of the generated electrical sensor signal (ES). In the shown embodiment, the inertial sensor 55 can be carried by the liquid container carrier 140. Further, the detector signal (DS) such as, for example, the radio signal (RS), can comprise or is the inertial sensor signal (IS).

In detail, the liquid container carrier 140 can comprise a plurality of holding elements 150, 160 for holding the laboratory liquid container 130. The detector 50, in particular its signal output 80 in the form of the wireless signal output 81, 82, its electrical power supply 67 and its inertial sensor 55 can be mounted at the plurality of holding elements 150, 160 of the liquid container carrier 140.

In particular, the detector 50 can comprise logic 58 on a printed circuit board 59. The logic 58 can be in electrical and/or signal connection with the electrical sensor 60, the signal output 80, the inertial sensor 55 and the power supply 67. Furthermore, the logic 58 and the printed circuit board 59 can be carried by the liquid container carrier 140. In detail, the logic 58 and the printed circuit board 59 can be mounted at the plurality of holding elements 150, 160 of the liquid container carrier 140.

FIG. 4 shows a laboratory automation system 10 comprising the laboratory liquid distribution system 100. The laboratory liquid distribution system 100 can comprise a plurality of liquid container carriers 140, a transport plane 110, a number, in the shown embodiment a plurality, of drive elements 120, a control device 125 and the detector system 90 comprising the detector 50. In alternative embodiments, it may be sufficient, if the laboratory liquid distribution system does not comprise the whole detector system but only its detector. Each of the plurality of liquid container carriers 140 can be configured to carry at least one, in the shown embodiment only one, laboratory liquid container 130 containing a liquid 139. The transport plane 110 can be configured to support the plurality of liquid container carriers 140. The plurality of drive elements 120 can be configured to move the plurality of liquid container carriers 140 on the transport plane 110. The control device 125 can be configured to control the plurality of drive elements 120 such that the plurality of liquid container carriers 140 can move on the transport plane 110 along corresponding transport paths such that each of the liquid container carriers 140 along an individual transport path simultaneously.

In detail, the plurality of liquid container carriers 140 can be translationally moved in two dimensions x, y substantially perpendicular to each other on or over the transport plane 110. In the shown embodiment, each of the plurality of liquid container carriers 140 can comprise a sliding surface, wherein the sliding surface can be configured to be in contact with the transport plane 110 and can enable performing movements such as, for example, slides, of the corresponding liquid container carrier 140 on the transport plane 110. In one embodiment, the laboratory liquid distribution system 100 can comprise a plurality of liquid container carriers 140. Self-evidently, more than the three liquid container carriers 140 depicted in FIG. 4 may be comprised in the laboratory liquid distribution system 100. One of the liquid container carriers 140 can carry the detector 50 and can be part of the detector system 90.

In the shown embodiment, each of the plurality of liquid container carriers 140 can comprise a magnetically active device 145, as shown in FIG. 5. The plurality of drive elements 120 can comprise a number, in the shown embodiment a plurality, of electro-magnetic actuators 121. The plurality of electro-magnetic actuators 121 can be stationary arranged below the transport plane 110 and can be configured to move the plurality of liquid container carriers 140 on the transport plane 110 by applying a magnetic drive force to the plurality of liquid container carriers 140. The control device 125 can be configured to control the plurality of electro-magnetic actuators 121 such that the plurality of liquid container carriers 140 can move on the transport plane 110 along corresponding transport paths. In alternative embodiments, the plurality of drive elements may comprise or be formed as a plurality of wheels driven by a plurality of corresponding electric motors located in the plurality of liquid container carriers and controllable by the control device.

In the shown embodiment, the magnetically active device 145 can be a permanent magnet. The plurality of electro-magnetic actuators 121 can be configured to generate a magnetic field. The magnetically active device 145 can be configured to interact with the magnetic field generated by the plurality of electro-magnetic actuators 121 such that the magnetic drive force can be applied to a corresponding liquid container carrier 140. The plurality of electro-magnetic actuators 121 can be implemented as a plurality of solenoids each having a solid ferromagnetic core. The electro-magnetic actuators 121 can be quadratically arranged in a grid having rows and columns such as, for example, in a plane substantially parallel to the transport plane 110. In each center of a quadrat formed by corresponding electro-magnetic actuators 121, no electro-magnetic actuator can be arranged. In other words, in each second row and in each second position, there can be no electro-magnetic actuator 121. Additionally, the electro-magnetic actuators 121 can be driven individually such as, for example, by the control device 125, in order to generate the magnetic field.

Furthermore, the laboratory liquid distribution system 100 can comprise a number, in the shown embodiment a plurality, of Hall-sensors 141. The plurality of Hall-sensors 141 can be arranged such that a position of a respective liquid container carrier 140 on the transport plane 140 can be sensed. The control device 125 can be functionally coupled to the Hall-sensors 141 for sensing the position of a respective liquid container carrier 140. The control device 125 can be configured to control the plurality of electro-magnetic actuators 121 in response to the sensed position(s).

Moreover, the laboratory automation system 10 can comprise a plurality of laboratory stations 20, 25. The laboratory liquid distribution system 100 can be configured to distribute the plurality of liquid container carriers 140 and/or the such as, for example, open, laboratory liquid containers 130 and/or the liquid/s 139 between the laboratory stations 20, 25.

The plurality of laboratory stations 20, 25 may comprise at least one pre-analytical, analytical and/or post-analytical station. In the shown embodiment, the laboratory stations 20, 25 can be arranged adjacent to the laboratory liquid distribution system 100 and its transport plane 110, respectively. Self-evidently, more than the two laboratory stations 20, 25 depicted in FIG. 4 may be comprised in the laboratory automation system 10.

The plurality of laboratory stations 20, 25 can require the laboratory liquid containers 130 to be open for processing such as, for example, analyzing, the liquid 139 contained in the corresponding laboratory liquid container 130. Thereby, an undesired displacement of the liquid 139 within the corresponding laboratory liquid container 130 may cause an undesired spilling out of the open laboratory liquid container 130 such as, for example, during the movement of the open laboratory liquid container 130 by the laboratory liquid distribution system 100 with a problem.

The detector system 90 and its detector 50, respectively, can reduce or prevent a spilling.'

In detail, the detector system 90 with its detector 50 can be moved by its liquid container carrier 140 on the transport plane 110 by the plurality of drive elements 120.

The liquid 139 does not fill the laboratory liquid container 130 completely such as, for example, up to the opening 131, as shown in FIGS. 1 and 2. Hence, in a problem-free state of the laboratory liquid container 130, the liquid 139 does not contact the electrical sensor 60 such as, for example, during the movement of the laboratory liquid container 130 by the laboratory liquid distribution system 100 without any problems.

In a problematic state of the laboratory liquid container 130, the liquid 139 can be displaced towards the electrical sensor 60 and can contact the electrical sensor 60 such as, for example, during the movement of the laboratory liquid container 130 by the laboratory liquid distribution system 100 with a problem. The displacement of the liquid 139 may be caused by an irregularity of the laboratory liquid distribution system 100.

The detector system 90 and its detector 50, respectively, can detect the irregularity such as, for example, when and/or where the irregularity occurs.

When the electrical sensor signal (ES) is generated, the wireless detector signal (DS) in the form of the light signal (LS) can be output. The light signal (LS) may be received by a light detector.

Additionally, when the electrical sensor signal (ES) is generated, the wireless detector signal (DS) in the form of the radio signal (RS) comprising the inertial sensor signal (IS) can be output.

The laboratory liquid distribution system 100 can comprise a signal receiver 126 in the form of a wireless signal receiver such as, for example, a radio receiver such as a Bluetooth receiver. The signal receiver 126 can be configured to receive the detector signal (DS) comprising the inertial sensor signal (IS). The control device 125 can be configured to cooperate with the signal receiver 126 and can be configured to control the plurality of drive elements 120 in dependence of the received detector signal (DS) comprising the inertial sensor signal (IS). In one embodiment, the control device 125 can be configured to control the plurality of drive elements 120 such that the electrical sensor 60 may not be contacted by the liquid 139 furthermore and thereby no further signal (DS, RS, IS) may be received by the signal receiver 126.

As the shown and above discussed embodiments reveal, a detector for a laboratory liquid distribution system to detect problems of the laboratory liquid distribution system is presented. Furthermore, a detector system comprising such a detector, a laboratory liquid distribution system comprising such a detector and/or such a detector system, a laboratory automation system comprising such a laboratory liquid distribution system and a use of such a detector with a laboratory liquid container containing a liquid in a laboratory liquid distribution system are also presented.

It is noted that terms like “preferably,” “commonly,” and “typically” are not utilized herein to limit the scope of the claimed embodiments or to imply that certain features are critical, essential, or even important to the structure or function of the claimed embodiments. Rather, these terms are merely intended to highlight alternative or additional features that may or may not be utilized in a particular embodiment of the present disclosure.

For the purposes of describing and defining the present disclosure, it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the present disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

I claim:

1. A detector for a laboratory liquid distribution system, the detector comprising:
an electrical sensor configured to be arranged at a laboratory liquid container within reach of a liquid contained in the laboratory liquid container and to generate an electrical sensor signal (ES) when the liquid contacts the electrical sensor.

2. The detector according to claim 1, wherein the electrical sensor is configured to cover an opening of the laboratory liquid container.

3. The detector according to claim 1, wherein the electrical sensor has a sensing area, wherein the electrical sensor is configured to generate the electrical sensor signal (ES) when the liquid contacts the sensing area and wherein the sensing area has a size in the range of 50 mm² to 400 mm².

4. The detector according to claim 1, wherein the electrical sensor comprises a pair of exposed electrodes configured to be electrically connected by the liquid and to generate the electrical sensor signal (ES) when the liquid contacts the pair of exposed electrodes.

5. The detector according to claim 1, further comprises,
a mount configured to mount the electrical sensor at the laboratory liquid container within reach of the liquid.

6. The detector according to claim 1, further comprises,
a signal output electrically connected with the electrical sensor and configured to output a detector signal (DS) in dependence of the generated electrical sensor signal (ES).

7. The detector according to claim 6, wherein the signal output is a wireless signal output, wherein the wireless signal output is configured to output the detector signal (DS) as a wireless detector signal (LS, RS).

8. The detector according to claim 1, further comprising,
an inertial sensor configured to be arranged in a region of the laboratory liquid container to cooperate with the electrical sensor and to generate an inertial sensor signal (IS) comprising an inertial value in dependence of the generated electrical sensor signal (ES).

9. A detector system for a laboratory liquid distribution system, the detector system comprising:
a laboratory liquid container containing a liquid; and
a detector according to claim 1, wherein the electrical sensor is arranged at the laboratory liquid container within reach of the liquid.

10. A detector system for a laboratory liquid distribution system, the detector system comprising:
a liquid container carrier, wherein the liquid container carrier is adapted to carry at least one laboratory liquid container containing a liquid; and
a detector according to claim 1, wherein the detector is carried by the liquid container carrier.

11. A laboratory liquid distribution system, the laboratory liquid distribution system comprising:
a plurality of liquid container carriers, wherein each of the plurality of liquid container carriers is configured to carry at least one laboratory liquid container containing a liquid;
a transport plane, wherein the transport plane is configured to support the plurality of liquid container carriers;
a plurality of drive elements configured to move the plurality of liquid container carriers on the transport plane;
a control device configured to control the plurality of drive elements such that the plurality of liquid container carriers moves on the transport plane along corresponding transport paths; and
a detector according to claim 1.

12. A laboratory liquid distribution system, the laboratory liquid distribution system comprising:
a plurality of liquid container carriers, wherein each of the plurality of liquid container carriers is configured to carry at least one laboratory liquid container containing a liquid;
a transport plane, wherein the transport plane is configured to support the plurality of liquid container carriers;
a plurality of drive elements configured to move the plurality of liquid container carriers on the transport plane;
a control device configured to control the plurality of drive elements such that the plurality of liquid container carriers moves on the transport plane along corresponding transport paths; and
a detector system according to claim 9.

13. The laboratory liquid distribution system according to claim 12, further comprising,
a signal receiver configured to receive the electrical sensor signal and/or the detector signal (DS, RS) and/or the inertial sensor signal (IS), wherein the control device configured to cooperate with the signal receiver and is configured to control the plurality of drive elements in dependence of the received electrical sensor signal and/or the received detector signal (DS, RS) and/or the received inertial sensor signal (IS).

14. The laboratory liquid distribution system according to claim 12, wherein each of the plurality of liquid container carriers comprises a magnetically active device, wherein the plurality of drive elements comprises a plurality of electro-magnetic actuators, wherein the plurality of electro-magnetic actuators is stationary arranged below the transport plane and is configured to move the plurality of liquid container carriers on the transport plane by applying a magnetic drive force to the plurality of liquid container carriers, and wherein the control device is configured to control the number of electro-magnetic actuators such that the plurality of liquid container carriers moves on the transport plane along corresponding transport paths.

15. A laboratory automation system, the laboratory automation system comprising:
a plurality of laboratory stations; and
a laboratory liquid distribution system according to claims 11, wherein the laboratory liquid distribution system is configured to distribute the plurality of liquid container carriers and/or laboratory liquid containers between the laboratory stations.

16. The use of a detector according to claim 1, with a laboratory liquid container containing a liquid in a laboratory liquid distribution system (100).
